(19) United States
(12) Patent Application Publication
(10) Pub. No.: US 2020/0160395 A1
(43) Pub. Date: May 21, 2020

(54) METHODS FOR PROVIDING TARGETED MEDIA CONTENT IN A VIRTUAL ENVIRONMENT AND DEVICES THEREOF

(71) Applicant: Cray Productions, LLC, Seoul (KR)

(72) Inventors: Sanjeev Kuwadekar, Porter Ranch, CA (US); Victor Sim, Seoul (KR); Spencer So, Fort Wayne, IN (US)

(21) Appl. No.: 16/689,548

(22) Filed: Nov. 20, 2019

(30) Foreign Application Priority Data
Nov. 20, 2018 (KR) 10-2018-0143917

(51) Int. Cl. G06Q 30/02; G06F 9/455; G06N 3/08

(52) U.S. Cl. CPC G06Q 30/0267; G06F 2009/45595; G06N 3/08; G06F 9/45558

(57) ABSTRACT

Methods, non-transitory computer readable media, and virtual content management apparatuses that assist providing targeted media content in a virtual environment includes identifying a subset of a plurality of influencer computing devices in a virtual environment based on influencer virtual activity data and influencer user profile data associated with users of each of the plurality of influencer computing devices. Next, influencer virtual location data is identified in the influencer virtual activity data associated with each of the identified subset of the influencer computing devices that matches with received content virtual location data. Received virual media content data placed within the identified influencer virtual location data and access of the placed virtual media content data is provided to one or more follower computing devices associated with the identified subset of influencer computing devices.

This application claims the benefit of U.S. Provisional Application No. 62/786,485 filed Dec. 30, 2018, and of Korean Application No. 10-2018-0143917, filed Nov. 20, 2018, which are hereby incorporated by reference in their entirety.

### FIELD

This technology generally relates to methods and devices for providing interactive media and, more particularly, to methods for providing targeted media content in a virtual environment and devices thereof.

### BACKGROUND

Providers of media content have a key goal of trying to accurately identify and target the right consumers using appropriate communication channels. In other words, providers of media content desire to deliver their message only to customers who are interested and receptive.

Unfortunately, to date existing technologies to try and enable these targeted communication have essentially relied upon brute force techniques of publishing media content to general populations with no possibility of tailoring based on the preference or activity of the user. For example, providing media content through online marketing typically involves targeting the general populations with only the limited possibility of tailoring based on demographic data, location or time of the day. In another example, the media content can be marketed by sharing the media content with online influencers and these influencers then broadcast the media content to their followers. In the latter approach, it is important to identify the online influencers for effective marketing and existing technologies uses real-life data such as fame, celebrity status, to identify the online influencers and their followers. However, the technique used by the existing technologies in online marketing might not be applicable to marketing in a virtual world because the virtual world would only include an avatar (or a representation) of a real-life person, but not the real-life person themselves. In other words, existing technologies face a technological problem with identifying the influencers and their associated followers in a virtual environment and provide targeted media content based on their tracked activities.

### SUMMARY

A method for providing targeted media content comprising identifying a subset of a plurality of influencer computing devices in a virtual environment based on influencer virtual activity data and influencer user profile data associated with users of each of the plurality of influencer computing devices. Next, influencer virtual location data is identified in the influencer virtual activity data associated with each of the identified subset of the influencer computing devices that matches with received content virtual location data. Received virual media content data placed within the identified influencer virtual location data and access of the placed virtual media content data is provided to one or more follower computing devices associated with the identified subset of influencer computing devices.

A non-transitory computer readable medium having stored thereon instructions for providing targeted media content comprising machine executable code which when executed by at least one processor, causes the processor to identify a subset of a plurality of influencer computing devices in a virtual environment based on influencer virtual activity data and influencer user profile data associated with users of each of the plurality of influencer computing devices. Next, influencer virtual location data is identified in the influencer virtual activity data associated with each of the identified subset of the influencer computing devices that matches with received content virtual location data. Received virual media content data placed within the identified influencer virtual location data and access of the placed virtual media content data is provided to one or more follower computing devices associated with the identified subset of influencer computing devices.

A virtual content management apparatus including at least one of configurable hardware logic configured to be capable of implementing or a processor coupled to a memory and configured to execute programmed instructions stored in the memory to identify a subset of a plurality of influencer computing devices in a virtual environment based on influencer virtual activity data and influencer user profile data associated with users of each of the plurality of influencer computing devices. Next, influencer virtual location data is identified in the influencer virtual activity data associated with each of the identified subset of the influencer computing devices that matches with received content virtual location data. Received virual media content data placed within the identified influencer virtual location data and access of the placed virtual media content data is provided to one or more follower computing devices associated with the identified subset of influencer computing devices.

Accordingly, this technology provides methods, non-transitory computer readable medium, and apparatuses that assist with providing targeted media content in a virtual environment. The disclosed technology solves the above illustrated technological problem by accurately identifying the influencers and their followers based on their interaction within a virtual environment via their computing devices and providing targeted media content based on their activity within the virtual environment. In other words, the disclosed technology provides a technological solution by tracking the activity of the computing devices of the consumers within a virtual environment and specifically identifying locations within the virtual environment to provide the media content, which is not routine, conventional, or well-understood.

### BRIEF DESCRIPTION OF THE DRAWINGS

FIG. 1 is a block diagram of a network environment including an example of virtual content management apparatus for providing targeted media content in a virtual environment;

FIG. 2 is an exemplary block diagram of the virtual content management apparatus;

FIG. 3 is an exemplary block diagram of a memory within the virtual content management apparatus;

FIG. 4 is an exemplary flowchart illustrating a method for providing targeted media content in a virtual environment;

FIG. 5 is an exemplary image illustrating the virtual environment;

FIG. 6 is an exemplary data flow block diagram to identify influencer computing devices;

FIG. 7 is an exemplary data flow block diagram to identify follower computing devices associated with the influencer computing devices;

FIG. 8 is an exemplary data flow block diagram to identify virtual locations to place the virtual media content; and

FIGS. 9A-9B are exemplary images illustrating the virtual media content placed within the virtual environment.

### DETAILED DESCRIPTION

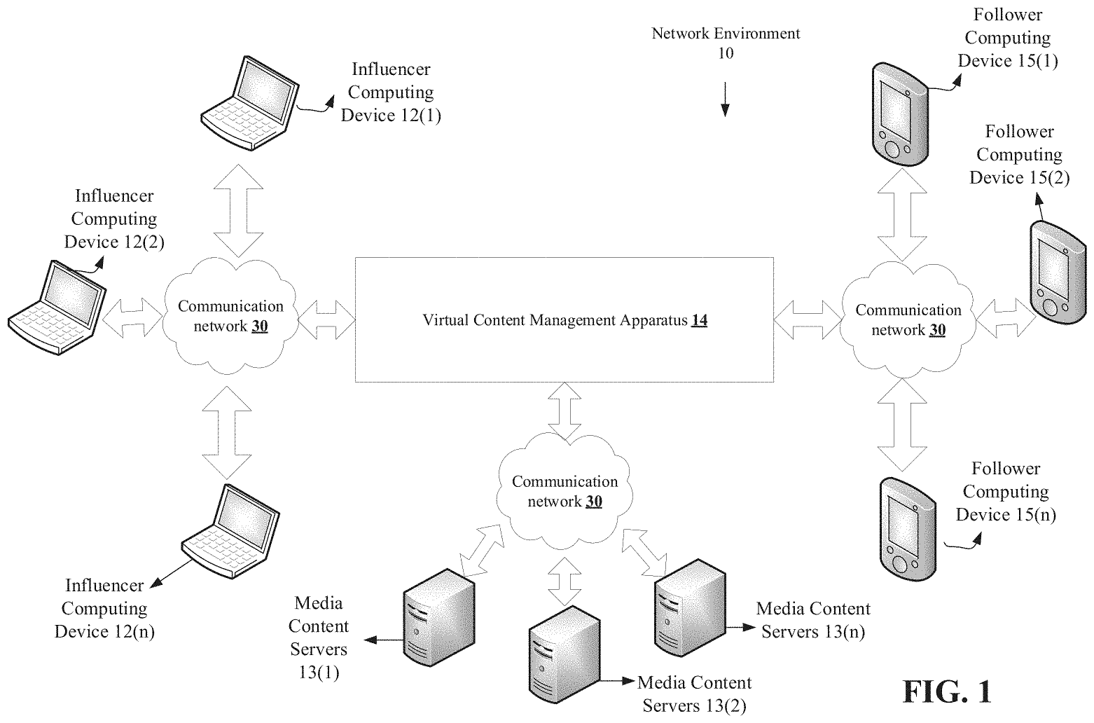

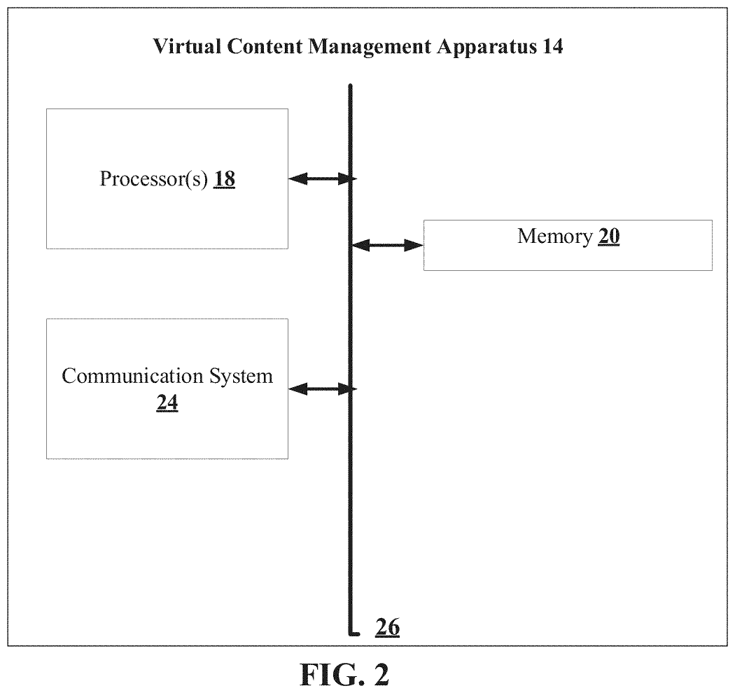

A network environment 10 with an example of a virtual content management apparatus 14 is illustrated in FIGS. 1-2. In this particular example, the environment 10 includes a plurality of influencer computing devices 12(1)-12(n), a plurality of media content servers 13(1)-13(n), the virtual content management apparatus 14, and a plurality of follower computing devices 15(1)-15(n), connected from a communication network 30, although the environment could include other types and numbers of systems, devices such as server devices, components, and/or other elements as is generally known in the art and will not be illustrated or described herein. This technology provides a number of advantages including providing methods, non-transitory computer readable medium, and apparatuses that provides a virtual and an interactive gaming environment.

Referring more specifically to FIGS. 1-2, the virtual content management apparatus 14 is programmed to assist with providing targeted media content in a virtual environment, although the apparatus can perform other types and/or numbers of functions or other operations and this technology can be utilized with other types of claims. In this particular example, the virtual content management apparatus 14 includes a processor 18, a memory 20, and a communication system 24 which are coupled together by a bus 26, although the virtual content management apparatus 14 may comprise other types and/or numbers of physical and/or virtual systems, devices, components, and/or other elements in other configurations.

The processor 18 in the virtual content management apparatus 14 may execute one or more programmed instructions stored in the memory 20 for sharing input/output devices for providing targeted media content in a virtual environment as illustrated and described in the examples herein, although other types and numbers of functions and/or other operations can be performed. The processor 18 in the virtual content management apparatus 14 may include one or more central processing units and/or general purpose processors with one or more processing cores, for example.

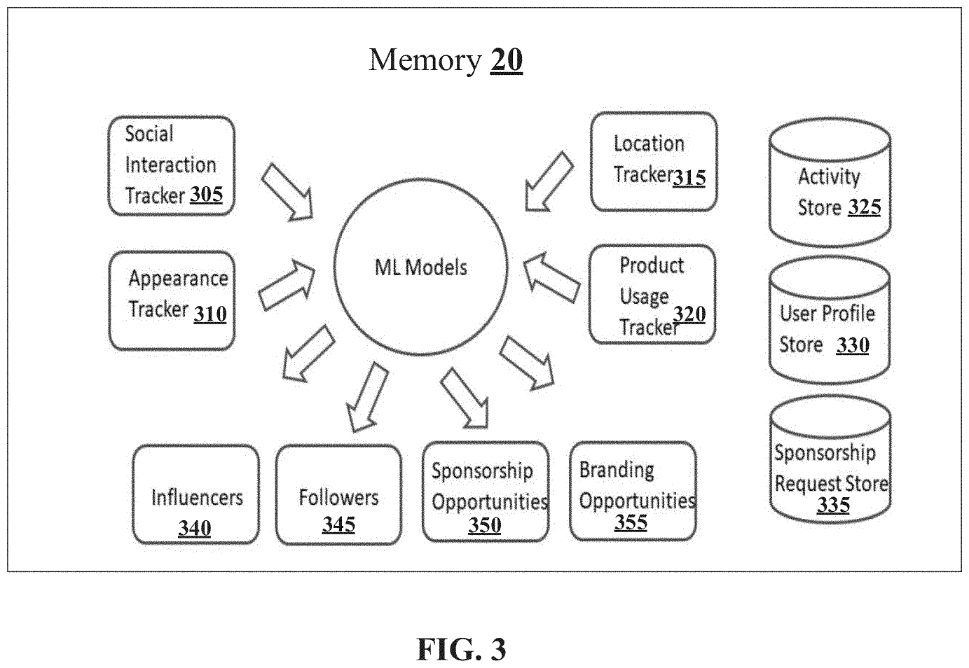

The memory 20 in the virtual content management apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20. Further, as illustrated in FIG. 3, memory 20 includes a social interaction tracker 305, an appearance tracker 310, a location tracker 315, a product usage tracker 320, an activity store 325, a user profile store 330, and a sponsorship request store 335, influencers identification engine 240, followers identification engine 345, sponsorship identification engine 350, and branding opportunities engine 355, although memory 20 can include other types or amounts of information. In this example, social interaction tracker 305 assists with tracking and storing interaction activities between the plurality of influencer computing devices 12(1)-12(n) and the plurality of follower computing devices 15(1)-15(n), although the social interaction tracker 305 can perform other types or amounts of functions. In this example, the social interaction activities include verbal communication, non-verbal communication, gesture, and posture. Verbal communication includes, for example, commenting on posts, commenting on photo albums, chatting between users, and the like. Non-verbal communication includes the liking of other users' posts or photo albums (e.g., liking). The gesture or posture includes a gesture or posture that the avatars corresponding to the user in the virtual world do when meeting on the street.

Next, the appearance tracker 310 assists with tracking and storing any avatar appearance changes, although the appearance tracker 310 can perform other types or amounts of functions. By way of example, the appearance tracker 310-tracks the appearance changes of the avatars representing users using the followers computing devices 15(1)-15(n) in the virtual world and stores the appearance change information in the activity store 325. For example, the appearance tracker 310 tracks appearance changes of the avatar's physical structure, accessories, facial expressions, hairstyles, races, clothing, etc.

Next, the location tracker 315 assists with tracking and storing locations visited by the player via the plurality of follower computing devices 15(1)-15(n) within the virtual environment, although the location tracker 315 can perform other types or amounts of functions. In this example, location tracker 315 tracks the users using the follower computing devices 15(1)-15(n) visiting places in the virtual world and stores the visit information in the activity store 325, although the data can be stored at other memory locations. The location tracker 315 stores visit information which includes location of places visited by users via the plurality of follower computing devices 15(1)-15(n), visit route, name of the place, interaction information or activity information in the place (e.g., participation and ranking in a game or a contest), number of visits etc. in the activity store 325.

Additionally in this example, the product usage tracker 320 assists with tracking and storing the usage of the virtual environment of the plurality of influencer computing devices 12(1)-12(n), although the product usage tracker 320 can be configured to perform other types of functions. By way of example, product usage tracker 320 tracks users using the plurality of follower computing devices 15(1)-15(n) use of the product in the virtual world and stores product usage information in the activity store 325. The products include products such as clothing, beverages, cosmetics, food tools etc. and services such as hair styling and make-up etc.

Furthermore in this example, the activity store 325 assists with storing the activity of the players, although the activity store can be configured to store other types or amounts of information.

Further in this example, the a user profile store 330 assists with storing the data associated with the profile of the user using the virtual environment via the plurality of influencer computing devices 12(1)-12(n), although the user profile store 330 can store other types or amounts of information. By way of example, the user profile store 330 stores a profile of users using the plurality of followers computing devices 15(1)-15(n) participating in the virtual environment. The profile includes the user's gender, age, address, education, hobby, preferences, demographic information, and other types of descriptive information. The profile may further include other information such as an image or video provided by the user.

Next, the sponsorship request store 335 assists with storing data relating to sponsorship requests, although the sponsorship request store 335 can store other types or amounts of data. In this example, sponsorship request store 335 stores the sponsorship information received from the advertiser via the plurality of media content servers 13(1)-13(n). The sponsorship information includes advertisement contents (e.g., a brand name, a product image, a service image, and the like) provided by an advertiser via the plurality of media content servers 13(1)-13(n) displayed in an appearance of an object of a virtual world, and a compensation amount given when the advertisement content is advertised. The sponsorship information may also include a landing page that includes descriptive information of the advertisement content that is induced when the user interacts with the object through the virtual world, or a network address from which a product or service corresponding to the ad content may be purchased.

Furthermore, the influencers identification engine 340 assists with extracting influential identification attributes of each user participating in the virtual world using the activity information stored in the activity store 325 and the user profile stored in the user profile store 330 and uses the attributes to identify influencers computing devices 12(1)-12(n) among computing devices. In this example, the influential identification engine 340 attributes include the start of new activities or interactions, out-of-the-box strategies, ability to motivate other users, good communication skills, creativity, innovativeness, and the ability to get along well with others etc. Further, the influencer identification module 340 identifies the influencer computing devices 12(1)-12(n) among users based on the value of this attribute. Furthermore, in this example, the influencer identification module 340 may use the machine learning model such as artificial neural network to identify the influencer computing devices 12(1)-12(n).

Additionally, the followers identification engine 345 in this example assists with, uses the activity information stored in the activity storage 325 and the user profile stored in the user profile store 330 to identify the follower computing devices 15(1)-15(n) to influencer computing devices 12(1)-12(n) identified in the influencer identification module 340 among the users. The follower identification engine 345 extracts users' follower identification attributes using the activity information and the user profile, and identifies followers for each influencers using the attributes. Here, the follower identification attributes include participation in activities or interactions that are initiated by the influencer, passive activities, simple rule compliance, no out-of-the-box strategies, lack of creativity or innovation, and abandon midway game. In this example, the follower identification engine 345 may use the machine learning model such as artificial neural network to identify the influencer computing devices 12(1)-12(n) and follower computing devices 15(1)-15(n) associated with the influencer computing devices 12(1)-12(n).

Further, in this example, the sponsorship opportunities engine 350 assists with providing the sponsorship opportunity provided by the advertiser via the media content servers 13(1)-13(n) ultimately selected in the branding opportunity engine 355 to the influencer computing device 12(1)-12(n). The sponsorship opportunities engine 350 may provide the sponsorship information provided by the advertiser via the media content servers 13(1)-13(n) to the influencer computing devices 12(1)-12(n) and receive acceptance. Alternatively, the sponsorship opportunities engine 350 tracks the influencer computing devices 12(1)-12(n) activity of placing the advertiser's advertisement content present in the media content servers 13(1)-13(n) on view of the virtual object in the virtual world associated with the influencer computing devices 12(1)-12(n) and stores the tracking information to the sponsorship request store 335, although the tracking information can be stored at other memory locations. Additionally, the sponsorship opportunities engine 350 analyzes the advertising activities of the influencer computing devices 12(1)-12(n) according to the advertiser's compensation standard and pays the influencers compensation amount. The amount of the compensation includes the virtual currency or product that can be used in the virtual world and the actual money that is transferred to the account of the influencer etc. Additionally in this example, the branding opportunities engine 355 assists with providing the media content servers 13(1)-13(n) with the information of each influencer computing devices 12(1)-12(n) and the information of the follower computing device 15(1)-15(n) linked to each of the influencer computing devices 12(1)-12(n), thereby providing an opportunity for advertisers via the media content servers 13(1)-13(n) to advertise. Herein, the information of the influencer computing devices 12(1)-12(n) includes the statistics of the products or services used by the influencer computing devices 12(1)-12(n) in the virtual world, various activities of the virtual world of the influencer computing devices 12(1)-12(n), profiles etc. and the information of the follower computing devices 15(1)-15(n) includes various statistics such as gender, age, hobby and so on. In this example, the branding opportunities engine 355 allows advertisers via the media content servers 13(1)-13(n) to participate in the auction through the real-time bid engine.

For example, the branding opportunities engine 355 may provide information about influencer computing devices 12(1)-12(n) and follower computing devices 15(1)-15(n) that are appropriate for each advertiser via the media content servers 13(1)-13(n) according to the nature of the advertisers, so as to participate in the bid. Advertisers via the media content servers 13(1)-13(n) provide sponsorship information when participating in bidding. Here, the sponsorship information may include an advertisement content to be displayed on the appearance of the virtual object of the virtual world, a compensation amount, and a compensation standard. The branding opportunities engine 355 may finally select a advertiser via the media content servers 13(1)-13(n) who presents the most compensation amount among the advertisers participating in the bidding for each influencer computing devices 12(1)-12(n). The branding opportunities engine 355 stores the sponsorship information of the last selected advertiser in the sponsorship request store 335.

The communication system 24 in the virtual content management apparatus 14 operatively couples and communicates between plurality of influencer computing devices 12(1)-12(n), the plurality of media content servers 13(1)-13(n), the virtual content management apparatus 14, and the plurality of follower computing devices 15(1)-15(n) which are all coupled together by one or more of the communication networks 30, although other types and numbers of communication networks or systems with other types and numbers of connections and configurations to other devices and elements. By way of example only, the communication networks can use TCP/IP over Ethernet and industry-standard protocols, including NFS, CIFS, SOAP, XML, LDAP, SCSI, and SNMP, although other types and numbers of communication networks, can be used. The communication network 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. Alternatively, the communication network can include any telecommunication protocols such as 3G, 4G, LTE, or 5G, by way of example.

In this particular example, each of the plurality of influencer computing devices 12(1)-12(n) may communicate with the virtual content management apparatus 14 to interact with the virtual environment hosted by the virtual content management apparatus 14, although the plurality of influencer computing devices 12(1)-12(n) can interact with the virtual content management apparatus 14 for other purposes. Each of the plurality of influencer computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements. In this example, the plurality of influencer computing devices 12(1)-12(n) can be a laptop, personal computer, a smartphone, tablet, although the gaming computing devices can include other types of devices.

Additionally in this example, each of the plurality of media content servers 13(1)-13(n) may communicate with the virtual content management apparatus 14 to provide media content, although the plurality of media content servers 13(1)-13(n) can interact with the virtual content management apparatus 14 for other purposes. Each of the plurality of media content servers 13(1)-13(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

Furthermore, in this example, each of the plurality of follower computing devices 15(1)-15(n) may communicate with the virtual content management apparatus 14 to interact with the virtual environment hosted by the virtual content management apparatus 14, although the plurality of follower computing devices 15(1)-15(n) can interact with the virtual content management apparatus 14 for other purposes. Each of the plurality of follower computing devices 15(1)-15(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements. In this example, the plurality of follower computing devices 15(1)-15(n) can be a laptop, personal computer, a smartphone, tablet, although the gaming computing devices can include other types of devices.

Although the exemplary network environment 10 with the virtual content management apparatus 14, the plurality of media content servers 13(1)-13(n), the plurality of follower computing devices 15(1)-15(n), and the plurality of influencer computing devices 12(1)-12(n), is described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s). The disclosed technology can be implemented as module or components of another application. Further, the disclosed technology can be implemented as operating system extensions, module, plugins, or the like. The disclosed technology can be implemented as module or components of another application. Further, the disclosed technology can be implemented as operating system extensions, module, plugins, or the like. Even further, the disclosed technology may be operative in a cloud-based computing environment. The disclosed technology can be executed within virtual machine(s) or virtual server(s) that may be managed in a cloud-based computing environment. Also, the disclosed technology, including the virtual content management apparatus 14 itself, may be located in virtual server(s) running in a cloud-based computing environment rather than being tied to one or more specific physical network computing devices. Also, the disclosed technology may be running in one or more virtual machines (VMs) executing on the virtual content management apparatus 14. Additionally, in at least one of the various embodiments, virtual machine(s) running on the virtual content management apparatus 14 may be managed or supervised by a hypervisor.

Although the virtual content management apparatus 14 is illustrated as single device, one or more actions of the virtual content management apparatus 14 may be distributed across one or more distinct computing devices. Moreover, the virtual content management apparatus 14 is not limited to a particular configuration. Thus, the virtual content management apparatus 14 may contain a plurality of computing devices that operate using a master/slave approach, whereby one of the computing device of the virtual content management apparatus 14 operate to manage and/or otherwise coordinate operations of the other network computing devices. The virtual content management apparatus 14 may operate as a plurality of network computing devices within cluster architecture, a peer-to peer architecture, virtual machines, or within a cloud architecture.

Thus, the technology disclosed herein is not to be construed as being limited to a single environment and other configurations and architectures are also envisaged. For example, the virtual content management apparatus 14 in FIG. 1 can operate within other computing devices (not shown) rather than as a stand-alone computing device.

While the virtual content management apparatus 14 is illustrated in this example as including a single device, the virtual content management apparatus 14 in other examples can include a plurality of devices or blades each with one or more processors each processor with one or more processing cores that implement one or more steps of this technology. In these examples, one or more of the devices can have a dedicated communication interface or memory. Alternatively, one or more of the devices can utilize the memory, communication interface, or other hardware or software components of one or more other communicably coupled of the devices. Additionally, one or more of the devices that together comprise virtual content management apparatus 14 in other examples can be standalone devices or integrated with one or more other devices or applications, for example. Moreover, one or more of the devices of the virtual content management apparatus 14 in these examples can be in a same or a different communication network including one or more public, private, virtual or cloud networks, for example.

One or more of the components depicted in the network environment, such as the virtual content management apparatus 14, for example, may be configured to operate as virtual instances on the same physical machine. In other words, the virtual content management apparatus 14 illustrated in FIG. 1 may operate on the same physical device rather than as separate devices communicating through a network as depicted in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

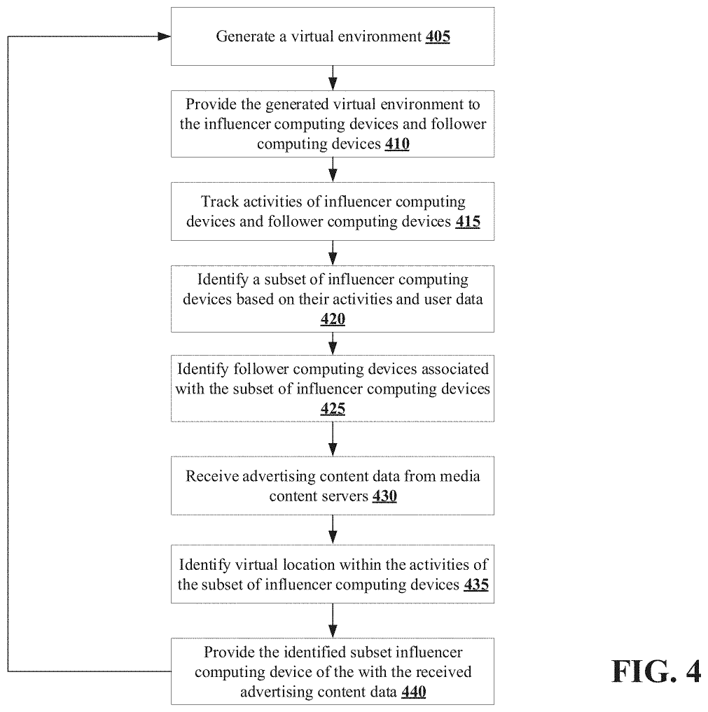

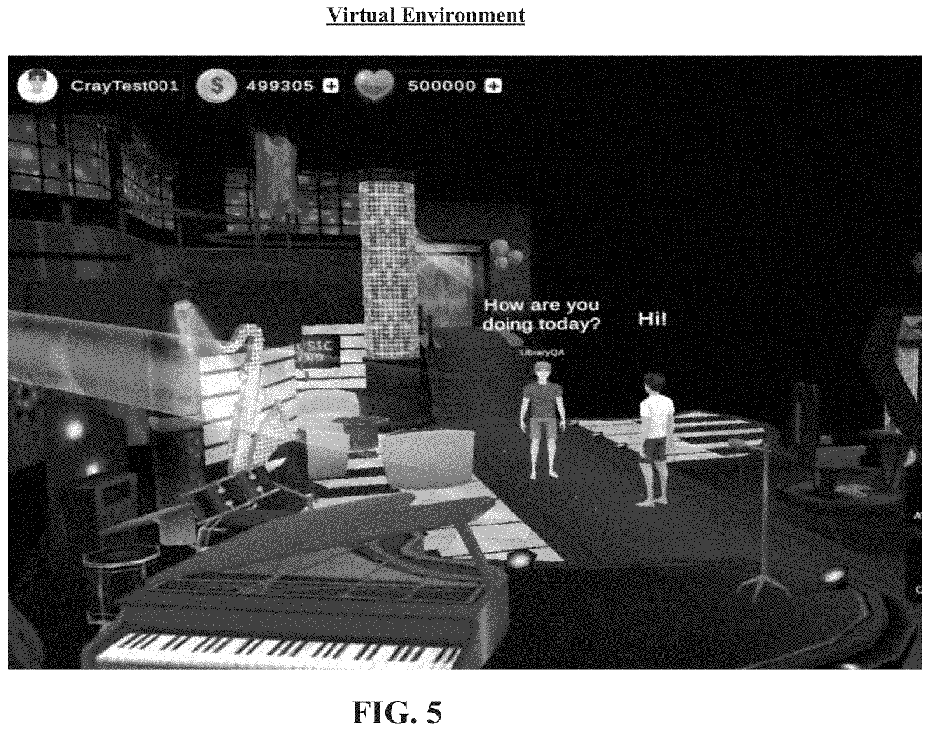

An example of a method for providing targeted media content in a virtual environment will now be described with reference to FIGS. 1-9B. The exemplary method begins at step 405 where the virtual content management apparatus 14 generates a virtual environment including a virtual platform for virtual games, virtual objects, virtual places or locations, virtual products, and/or virtual social networks, although the virtual content management apparatus 14 can generate the virtual environment including other types or amounts of information. By way of example, one of the virtual environment generated by the virtual content management apparatus 14 is illustrated in FIG. 5.

Next in step 410, the virtual content management apparatus 14 provides the generated virtual environment to the plurality of influencer computing devices 12(1)-12(n) and the plurality of follower computing devices 15(1)-15(n). In this example, the plurality of influencer computing devices 12(1)-12(n) and the plurality of follower computing devices 15(1)-15(n) can use the provided virtual environment to interact with each other and also interact with virtual objects and virtual places within the virtual environment. Additionally in this example, the virtual content management apparatus 14 places an avatar associated with each of the plurality of influencer computing devices 12(1)-12(n) and the plurality of follower computing devices 15(1)-15(n), that can be used to interact with the virtual object, the virtual place, although other techniques can be used to interact with the provided virtual environment. Furthermore, in this example, the virtual content management apparatus 14 assigns a unique identification number to each of the plurality of follower computing devices 15(1)-15(n) and the plurality of influencer computing devices 12(1)-12(n) that interact with the provided virtual environment.

In step 415, the virtual content management apparatus 14 using the social interaction tracker 305, the appearance tracker 310, the location tracker 315, and the product usage tracker 320 tracks the activities of the plurality of influencer computing devices 12(1)-12(n) and the follower computing devices 15(1)-15(n) using the virtual environment, although other techniques can be used to track the activities of the plurality of influencer computing devices 12(1)-12(n) and the follower computing devices 15(1)-15(n). In this example, the activities tracked by the virtual content management apparatus 14 using the social interaction tracker 305, the appearance tracker 310, the location tracker 315, and the product usage tracker 320 include changing the appearance of avatars, visiting places in a virtual world, and using virtual products in a virtual world, although the virtual content management apparatus 14 can track other types or amounts of activities. In addition to tracking, the virtual content management apparatus 14 stores the tracked activity associated with each of the plurality of influencer computing devices 12(1)-12(n) and the plurality of follower computing devices 15(1)-15(n) along with their unique identification number associated with each of the plurality of influencer computing devices 12(1)-12(n) and the follower computing devices 15(1)-15(n) within the activity store 325. Furthermore, the virtual content management apparatus 14 stores the user data associated with the users of the plurality of influencer computing devices 12(1)-12(n) and the plurality of follower computing devices 15(1)-15(n) along with their unique identification number within the user profile store 330, although the user data can be stored at other memory locations. By way of example, the data associated with the users includes such as name, type of device, interested activities, although the user data can include other types or amounts of information.

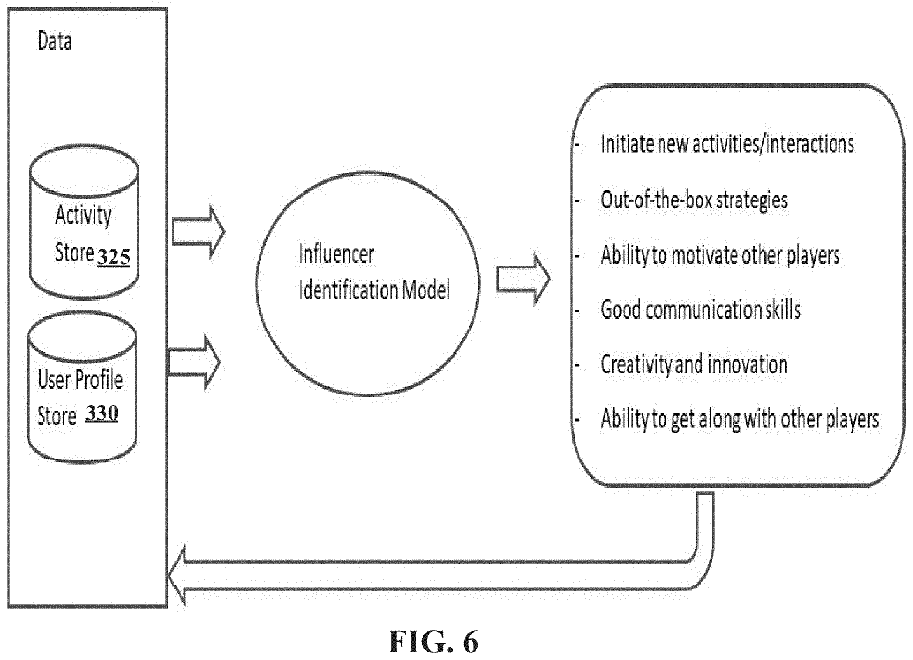

In step 420, the virtual content management apparatus 14 identifies a subset of influencer computing devices from the plurality of influencer computing devices 12(1)-12(n) using the influencer identification engine 340 to send one or more of a plurality of advertising content based on the tracked and user profile data, although other techniques and/or parameters can be used to identify the subset of influencer computing devices from the plurality of influencer computing devices 12(1)-12(n). In this example, the virtual content management apparatus 14 can use an influencer identification artificial intelligence model to identify the subset of influencer computing devices and an example is described herein with reference to FIG. 6. By way of example, the virtual content management apparatus 14 obtains the tracked activity information from the activity store 325 and the data associated with the users of the plurality of influencer computing devices 12(1)-12(n) from the user profile store 330 based on the unique identification number corresponding to the each of the unique identification number of the plurality of influencer computing devices 12(1)-12(n) and applies an influencer identification artificial intelligence model (a neural network model) on the obtained data. Further, the virtual content management apparatus 14 through the influencer identification artificial intelligence model using the parameters illustrated in FIG. 6 can identify the subset of the influencer computing devices from the plurality of influencer computing devices 12(1)-12(n). By way of example, the influencer identification artificial intelligence model identifies the subset of influencer computing devices by tracking the influencer computing devices that start new activities within the virtual environment, ability to motivate other computing devices including the plurality of influencer computing devices 12(1)-12(n) and the plurality of follower computing devices 15(1)-15(n) to use the provided virtual environment through exchange of messages within the virtual environment, although other parameters can be used to identify the subset of influencer computing devices from the plurality of influencer computing devices 12(1)-12(n). Alternatively in another example, the virtual content management apparatus 14 can also identify the subset of influencer computing devices from the plurality of influencer computing devices 12(1)-12(n) based on a request to be identified as a subset of influencer computing devices from the from the plurality of influencer computing devices 12(1)-12(n).

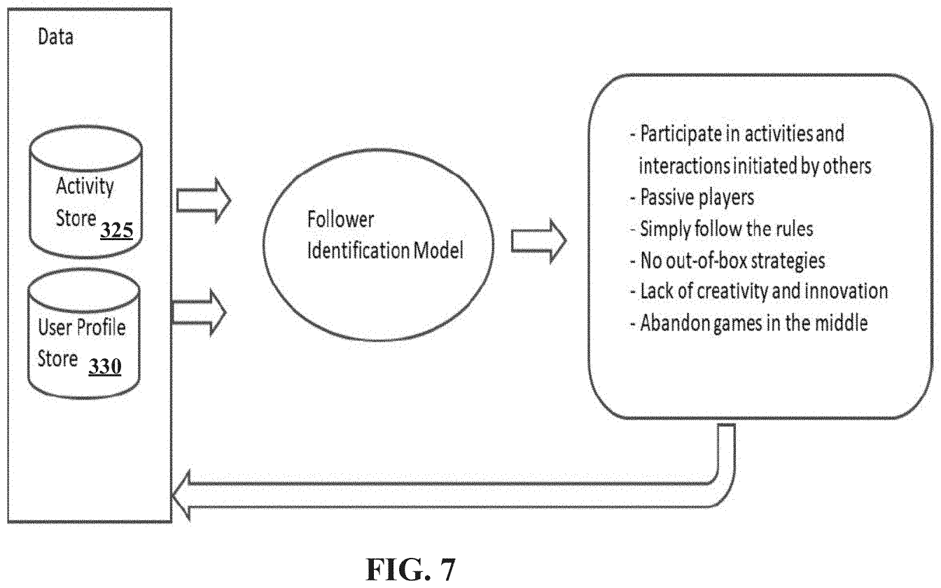

In step 425, the virtual content management apparatus 14 identifies one or more of the plurality of follower computing devices 15(1)-15(n) that are associated with each of the identified subset of the influencer computing devices based on the tracked activity and user profile data, although the virtual content management apparatus 14 can identify one or more of the plurality of follower computing devices 15(1)-15(n) that are associated with each of the identified subset of the influencer computing devices using other techniques. In this example, the step of identifying one or more of the plurality of follower computing devices 15(1)-15(n) that are associated with each of the identified subset of the influencer computing devices can be performed by applying a follower identification artificial intelligence model which will be further illustrated now with reference to FIG. 7. As illustrated in FIG. 7, the virtual content management apparatus 14 obtains the tracked activity information from the activity store 325 and the data associated with the users of the plurality of follower computing devices 15(1)-15(n) from the user profile store 330 based on the unique identification number corresponding to the each of the plurality of follower computing devices 15(1)-15(n). Next, the virtual content management apparatus 14 applies a follower identification artificial intelligence model (a neural network) to identify the follower computing device(s) associated with the subset of influencer computing device based on the parameters illustrated in FIG. 7. By way of example, the follower identification artificial intelligence model identifies a follower computing device to be associated with the influencer computing device when a follower computing device participates in an activity initiated by an influencer computing device, although other parameters such as compliance with the rules set forth by the influencer computing device, completion of the activity initiated by the influencer computing device can be used to identify the follower computing device being associated to the influencer computing device.

In step 430, the virtual content management apparatus 14 receives advertising content data including advertising videos, products, audios, images, textual data, speech data, from the plurality of media content servers 13(1)-13(n), although the virtual content management apparatus 14 can receive other types of advertising content data from other devices. In addition to the receiving the advertising content data, the virtual content management apparatus 14 also receives the request including the locations at which the advertising content data is required to be placed, although the request can include other types or amounts of information.

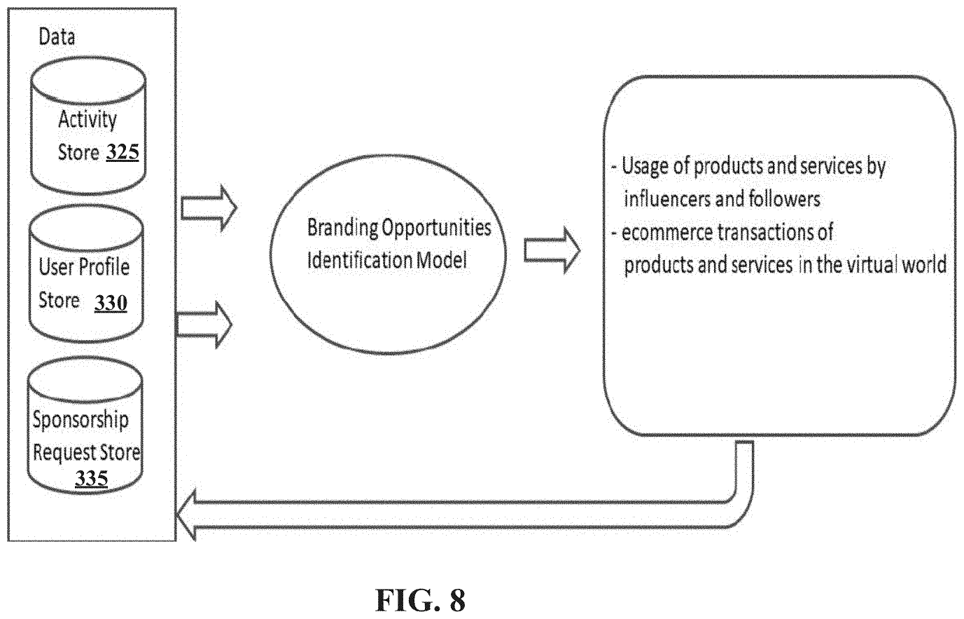

In step 435, the virtual content management apparatus 14 identifies one or more a virtual locations within the virtual activities of each of the identified subset of influencer computing devices to place the received advertising content based on the received request, tracked activity data and the user data associated with each of the identified subset of influencer computing devices, although the virtual content management apparatus 14 can place the received advertising content at other locations based on other parameters. The step of identifying the one or more virtual locations within the virtual activity is further illustrated in FIG. 8. By way of example, the virtual content management apparatus 14 obtains the tracked activity of each of the identified subset of influencer computing devices from the activity store 325 and the user data associated with the users of the identified subset of influencer computing devices from the user profile store 330 based on the unique identification number associated with each of the identified subset of influencer computing devices. Further, the virtual content management apparatus 14 executes a branding opportunities identification artificial intelligence model on the obtained activity data, user profile data, and the received request data to identify the one or more virtual locations based on the parameters illustrated in FIG. 8. The virtual content management apparatus 14 executes the above illustrated steps for each of the influencer computing device within the subset of the identified influencer computing devices. By way of example, if the received request includes the advertising content data to be placed in a virtual barbeque area, the obtained activity data and the user data indicates that the activity is within virtual beach, then the branding opportunities identification artificial intelligence model identifies a virtual location with a barbeque area within the virtual beach.

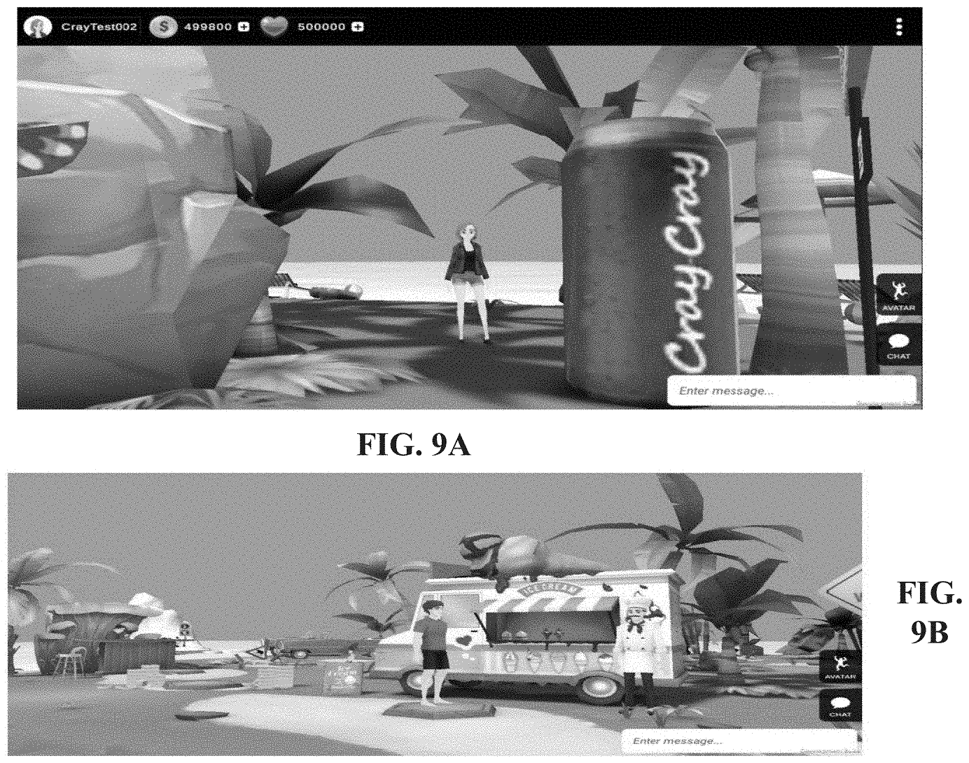

In step 440, the virtual content management apparatus 14 places the received advertising content data at the identified virtual locations within the virtual activity in each of the identified subset of the influencer computing devices. By way of example, FIGS. 9A-9B illustrates placing the received advertising content data at the identified virtual location. For purpose of further illustration of FIG. 9A, if the received advertising content data includes a virtual soft drink can that was requested to be placed near the barbeque area, then the virtual content management apparatus 14 places the virtual software drink within the barbeque area of the virtual beach (activity of the influencer). Similarly, with reference to FIG. 9B, if the received advertising content data includes a virtual ice cream van to be placed in a park, then the virtual content management apparatus 14 places the virtual ice cream van within the barbeque area of the virtual park (activity of the influencer). The exemplary flow proceeds back to step 405. Accordingly, by placing the receiving advertising content data within the virtual location, only the identified follower computing devices associated with the influencer computing device would be able to view the advertising content data and accordingly will be able to provide a more targeted advertising media content. Optionally in this example, upon placing the received advertisement content data within the virtual location, the influencer computing device can also be compensated for the hosting the advertising content data and the compensation can include virtual currency or product that can be used in the virtual world and the actual money, by way of example.

Optionally in this example, the virtual content management apparatus 14 can continue to track the activities of the influencer computing device and the follower computing device within the virtual environment and move up the follower computing device to the status of an influencer computing device or move down the influencer computing device to a follower computing device. By way of example, the virtual computing apparatus 14 can take the decision of moving up or moving down based on the tracked activity and the number of follower computing device for each of the influencer computing devices.

Accordingly, this technology provides methods, non-transitory computer readable medium, and apparatuses that assist with providing targeted media content in a virtual environment. The disclosed technology solves the above illustrated technological problem by accurately identifying the influencers and their followers based on their interaction within a virtual environment via their computing devices and providing targeted media content based on their activity within the virtual environment. In other words, the disclosed technology provides a technological solution by tracking the activity of the computing devices of the consumers within a virtual environment and specifically identifying locations within the virtual environment to provide the media content, which is not routine, conventional, or well-understood.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method comprising:
identifying, by a computing device, a subset of a plurality of influencer computing devices in a virtual environment based on influencer virtual activity data and influencer user profile data associated with users of each of the plurality of influencer computing devices;
identifying, by the computing device, influencer virtual location data in the influencer virtual activity data associated with each of the identified subset of the influencer computing devices that matches with received content virtual location data; and
placing, by the computing device, received virual media content data placed within the identified influencer virtual location data, and providing access of the placed virtual media content data to one or more follower computing devices associated with the identified subset of influencer computing devices.

2. The method as set forth in claim 1 further comprising, identifing, by the computing device, the one or more follower computing devices associated with the identified subset of influencer computing devices based on follower virtual acitivity data and follower user profile data.

3. The method as set forth in claim 1 further comprising:
generating, by the computing device, the virtual environment comprising one or more virtual games, one or more virtual activities, or one or more social networks; and
providing, by the computing device, the generated virtual environment to the plurality of influencer computing devices and the plurality of follower computing devices.

4. The method as set forth in claim 3 further comprising, tracking, by the computing device, the influencer activity data associated with the plurality of influencer computing devices based on the interaction of the plurality of influencer computing devices with the provided virtual environment.

5. The method as set forth in claim 3 further comprising, tracking, by the computing device, the follower activity data associated with the plurality of follower computing devices based on the interaction of the plurlaity of follower computing devices with the provided virtual environment.

6. The method as set forth in claim 1 wherein the influencer virtual location data is identified by applying a neural network algorithm on the influencer virtual activity data and influencer user profile data associated with the plurality of influencer computing devices along with the received requested virtual location data.

7. A non-transitory computer readable medium having stored thereon instructions comprising executable code, which when executed by at least one processor, cause the processor to:
identify a subset of a plurality of influencer computing devices in a virtual environment based on influencer virtual activity data and influencer user profile data associated with users of each of the plurality of influencer computing devices;
identify influencer virtual location data in the influencer virtual activity data associated with each of the identified subset of the influencer computing devices that matches with received content virtual location data; and
place received virual media content data placed within the identified influencer virtual location data, and providing access of the placed virtual media content data to one or more follower computing devices associated with the identified subset of influencer computing devices.

8. The medium as set forth in claim 7 further comprising, identifing the one or more follower computing devices associated with the identified subset of influencer computing devices based on follower virtual acitivity data and follower user profile data.

9. The medium as set forth in claim 7 further comprising:
generating the virtual environment comprising one or more virtual games, one or more virtual activities, or one or more social networks; and
providing the generated virtual environment to the plurality of influencer computing devices and the plurality of follower computing devices.

10. The medium as set forth in claim 9 further comprising, tracking the influencer activity data associated with the plurality of influencer computing devices based on the interaction of the plurality of influencer computing devices with the provided virtual environment.

11. The medium as set forth in claim 9 further comprising, tracking the follower activity data associated with the plurality of follower computing devices based on the interaction of the plurlaity of follower computing devices with the provided virtual environment.

12. The medium as set forth in claim 7 wherein the influencer virtual location data is identified by applying a neural network algorithm on the influencer virtual activity data and influencer user profile data associated with the plurality of influencer computing devices along with the received requested virtual location data.

13. A computing device comprising:
a processor; and
a memory coupled to the processor which is configured to be capable of executing programmed instructions comprising and stored in the memory to:
identify a subset of a plurality of influencer computing devices in a virtual environment based on influencer virtual activity data and influencer user profile data associated with users of each of the plurality of influencer computing devices;
identify influencer virtual location data in the influencer virtual activity data associated with each of the identified subset of the influencer computing devices that matches with received content virtual location data; and
place received virual media content data placed within the identified influencer virtual location data, and providing access of the placed virtual media content data to one or more follower computing devices associated with the identified subset of influencer computing devices.

14. The device as set forth in claim 13 wherein the processor is further configured to be capable of executing the stored programmed instructions to identify the one or more follower computing devices associated with the identified subset of influencer computing devices based on follower virtual acitivity data and follower user profile data.

15. The device as set forth in claim 13 wherein the processor is further configured to be capable of executing the stored programmed instructions to:
generate the virtual environment comprising one or more virtual games, one or more virtual activities, or one or more social networks; and
provide the generated virtual environment to the plurality of influencer computing devices and the plurality of follower computing devices.

16. The device as set forth in claim 15 wherein the processor is further configured to be capable of executing the stored programmed instructions to track the influencer activity data associated with the plurality of influencer computing devices based on the interaction of the plurality of influencer computing devices with the provided virtual environment.

17. The device as set forth in claim 15 wherein the processor is further configured to be capable of executing the stored programmed instructions to track the follower activity data associated with the plurality of follower computing devices based on the interaction of the plurlaity of follower computing devices with the provided virtual environment.

18. The device as set forth in claim 13 wherein the the influencer virtual location data is identified by applying a neural network algorithm on the influencer virtual activity data and influencer user profile data associated with the plurality of influencer computing devices along with the received requested virtual location data.
